(19) United States
(12) Patent Application Publication
(10) Pub. No.: US 2002/0122109 A1
(43) Pub. Date: Sep. 5, 2002

(54) Laser pattern imaging of circuit boards with grayscale image correction

(76) Inventors: Ali R. Ehsani, Tucson, AZ (US); Thomas E. Chabreck, Tucson, AZ (US); John Engel, Tucson, AZ (US)

Correspondence Address: APPLIED MATERIALS, INC., Patent Department, P.O. Box 450A, Santa Clara, CA, 95052, US

(21) Appl. No.: 09/751,866

(22) Filed: Dec. 28, 2000

(51) Int. Cl. B41J 2/47; B41J 2/435

(52) U.S. Cl. 347/240; 347/251; 347/234; 347/248

(57) ABSTRACT

An apparatus for registering a laser patterned image on a circuit board has a controller operating laser beam source, modulating and scanning components capable of generating, modulating and scanning one or more laser beams across a circuit board held on a support. The controller provides a data signal to the components, the data signal comprising a grayscale image bitmap comprising image pixels having grayscale levels that correspond to fractional beam intensities.

### BACKGROUND

The present invention relates to laser pattern imaging of circuit boards.

The contact printing method of registering a circuit image on a printed circuit board involves a number of separate imaging and processing steps which are difficult and laborious to adapt to new circuit designs. Typically, a glass plate covered with photosensitive material is placed in a photo plotter and exposed to ultraviolet light to register a circuit image onto the photosensitive material. The exposed photosensitive material is developed, stabilized, inspected, touched up, and copied to make working photomasks. A photomask is then placed in contact with a circuit board preform and a photoresist layer on the preform exposed to ultraviolet light through the photomask to transfer the photomask image to the photoresist layer. The photoresist layer is then developed and stabilized. Thereafter, the circuit board preform is etched in conformance with the exposed photoresist layer to form a circuit board. Thus, contact printing involves multiple process steps to make and print with the photomasks, and these masks have to be remade to accommodate new circuits.

Laser direct imaging (LDI) methods provide a faster and more direct method of registering a circuit image on a circuit board. In LDI, a laser beam is modulated to register a laser patterned circuit image directly onto a photoresist layer of the circuit board. LDI eliminates the need for the photomask fabrication tools, such as the photomask and photo plotter. LDI machines can also be quickly reprogrammed to print other circuit images directly on the circuit board because the intermediate photomask fabrication step is not used. LDI can also improve circuit board yields and provide automated image scaling features.

However, current LDI methods often do not provide the image resolutions needed for complex circuit images having finer circuit line widths due to one or more of grid snapping errors, beam modulation errors, and scanning errors. Referring to FIG. 1, an image feature 20 of a circuit image 22 is encoded to a bitmap comprising image pixels that match corresponding addressable pixels 24 of a pixel grid 28 on a region of a circuit board. An array of laser beams is scanned parallel to vertical and horizontal lines 34, 36 of the pixel grid 28 according to an encoded image map. However, the spacing of the pixel grid 28 controls the size and location of the addressable pixels 24. Thus, when a curved line 38 of the image feature 20 is encoded and projected onto the pixel grid 28, the resultant image registered on the circuit board has a stepped edge 40 corresponding to the locations of the addressable pixels 24 that approximate the curvature of the line 38. Similarly, diagonal lines and circular lines are approximated to the addressable pixels 24 which are nearest to the actual positions of the lines, often resulting in distortion of the registered images. Furthermore, the edges of image lines which fall between the spacing of the vertical and horizontal lines 34, 36 of the pixel grid 28 are also approximated to be projected onto the closest lines 34, 36 leading to variations in the dimensions of the image lines which alter the electrical properties of the manufactured circuit. Additional image accuracy problems arise from scanning or beam positioning errors that typically occur during the scanning of the laser beam across the circuit board. For example, a typical scanning error is a beam bowing error which results in deviation of the laser beam path into a slight arc across the circuit board when a straight line is desired.

In addition, faulty laser beam focusing or scanning elements may also result in other imaging errors across the circuit board.

The imaging errors obtained in the registration of an image by LDI may be reduced by increasing imaging resolution, for example, by decreasing the spacing of the pixel grid 28. However, higher image resolution increases image processing and beam scanning time. For example, a two-fold increase in resolution along each axis of a two-axis image may increase the data processing time and the laser beam scanning time by a factor of 4. Also, the higher resolution requires more accurate laser beam components, such as for example, laser beam source, splitter, modulating and focusing components that generate a beam having a finer linewidth that may generate a more precisely scanned image on the circuit board. It is difficult to reduce the imaging errors while still providing production worthy imaging speeds.

Thus it is desirable to have a laser direct imaging apparatus and process capable of accurately registering a laser patterned of a circuit image of a circuit board. It is also desirable to reduce grid snapping, scanning, and beam positioning errors. It is further desirable have good image registration speeds to achieve the higher image resolution.

### SUMMARY

Embodiments of the present invention are capable of satisfying these needs. In one aspect, the present invention comprises an apparatus capable of registering a laser pattern image on a circuit board, the apparatus comprising laser beam source, modulating and scanning components capable of generating, modulating and scanning one or more laser beams across a circuit board held on a support, and a controller adapted to provide a data signal to operate the components to register a laser patterned image on the circuit board, the data signal relating to a grayscale image bitmap comprising image pixels that are assigned grayscale levels that correspond to fractional beam intensities.

In another aspect, the present invention comprises a method of registering a laser patterned image on a circuit board, the method comprising placing a circuit board on a support, and generating, modulating and scanning one or more laser beams across the circuit board on the support, in relation to a grayscale image bitmap comprising image pixels that are assigned grayscale levels that correspond to fractional beam intensities, to register a laser patterned image on the circuit board.

In another aspect, the present invention comprises an apparatus capable of registering a laser patterned image on a circuit board, the apparatus comprising laser beam source, modulating and scanning components capable of generating, modulating and scanning one or more laser beams across a circuit board held on a support, and a controller adapted to provide a data signal to operate the components to register a laser patterned image on the circuit board, the data signal derived from a contour image map.

In another aspect, the present invention comprises a method of registering a laser patterned image on a circuit board, the method comprising placing a circuit board on a support, and generating, modulating and scanning one or more laser beams across the circuit board on the support, in relation to a contour image map, to register a laser patterned image on the circuit board.

In another aspect, the present invention comprises an apparatus capable of registering a laser patterned image on a circuit board, the apparatus comprising laser beam source, modulating and scanning components capable of generating, modulating and scanning one or more laser beams across a circuit board held on a support, and a controller adapted to provide a data signal to operate the components to register a laser patterned image on the circuit board, the data signal adapted to compensate for a proximity error arising from image pixels located at the boundaries of image features of the laser patterned image to be registered on the circuit board.

In another aspect, the present invention comprises a method of registering a laser patterned image on a circuit board, the method comprising placing a circuit board on a support, and generating, modulating and scanning one or more laser beams across the circuit board on the support, to compensate for a proximity error arising from image pixels located at the boundaries of the image features of the laser patterned image to be registered on the circuit board.

### DRAWINGS

These features, aspects, and advantages of the present invention will become better understood with regard to the following description, appended claims, and accompanying drawings which illustrate examples of the invention. However, it is to be understood that each of the features can be used in the invention in general, not merely in the context of the particular drawings, and the invention includes any combination of these features, where:

FIG. 1 are schematic diagrams showing an image feature comprising a curved line and the stepped line that results when the curved line is imaged onto an addressable pixel grid of a circuit board;

FIG. 2 is a graph of Gaussian shaped illumination intensities provided by beam spots that are sized larger than addressable pixels and overlapping one another;

FIGS. 3 and 4 are graphs of beam intensities across individual beam spots and the summed beam intensity that results for a ratio of beam spot size to addressable pixel size of 1:1 and 2:1, respectively;

FIGS. 5 and 6 are graphs showing the changing shape of the summed beam intensity curve across a boundary of two addressable pixels when a beam that is fully on is projected on the first addressable pixel and a beam having a fractional beam intensity is projected onto a second addressable pixel, and for ratios of beam spot size to pixel size of 1:1 and 2:1, respectively;

FIGS. 7 and 8 are contour plots of the summed beam intensity values across an imaged feature showing the effect of illuminating the addressable pixels by according to a two-level or grayscale image bitmap, respectively;

FIG. 9 is a schematic sectional view of an embodiment of a circuit board;

FIG. 10 is a schematic diagram of one version of a circuit board imaging apparatus according to the present invention;

FIG. 11 is a block diagram of a computer-readable program according to the present invention; and

FIG. 12 is a flowchart of a data path from a CAD program to driver circuits of the controller of the image registration apparatus.

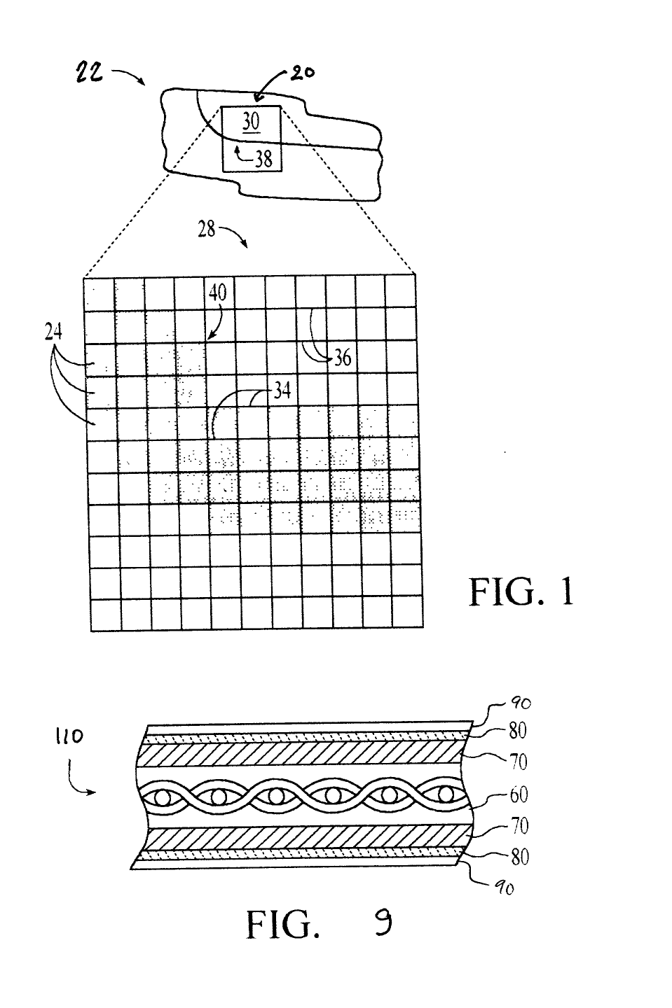

### DESCRIPTION

In laser direct imaging processes, a laser patterned image corresponding to a circuit image is registered on a circuit board. In the image patterning process, one or more laser beams are scanned across the circuit board and modulated according to an image map which may be in a vector or raster form, e.g. a vector image map or an image bitmap, to register a laser patterned image on the circuit board. Typically, the original circuit design is created in the form of a vector image map that has vectors that define a circuit image. The vector image map is subsequently converted to an image bitmap, such as a raster image bitmap, that contains a sequence of data bits that are used to modulate the laser beams to register a laser patterned image on the circuit board, for example, by turning on and off the laser beams as they are scanned across the circuit board. The resolution of the image bitmap (e.g., number of dots per inch) defines the accuracy of the image registration process. Conventional image bitmaps define two-level images, by which it is mean that the laser beams are either turned on or off. Typically, a two-level image bitmap comprises a binary bit sequence containing ‘on’ and ‘off’ states of the laser beams, e.g. 0s and 1s in a series of binary numbers, for example, 00111000111. The binary bit sequence represents a plurality of image pixels that each define an associated laser beam intensity for a laser beam spot to be projected onto an addressable pixel of the circuit board during scanning of the laser beams across the circuit board. The image pixels are of the image whereas the addressable pixels are the corresponding pixels on the circuit board.

In one aspect of the present invention, a grayscale image bitmap is generated from an image map of a circuit image to be registered on the circuit board. The grayscale image bitmap comprises image pixels that are assigned specific grayscale levels according to some predefined criteria. Each grayscale level represents a particular fractional beam intensity of a laser beam as the beam is scanned across a circuit board to generate a laser patterned image on the circuit board. The fractional beam intensities that correspond to beam intensities that are intermediate to, and lie between, the fully on and off states of the laser beam. The fractional beam intensities may be determined from a lookup table that defines beam intensities that correspond to each grayscale level, a formula, or other such equivalent functional approximations. The fractional beam intensities may also be directly proportional to the grayscale levels.

Each grayscale level is digitally represented by a grayscale bit set comprising a plurality of binary bits. For example, a grayscale bit set comprising n binary bits may be used to represent a maximum number of 2″ grayscale levels. Grayscale levels that are each defined by 4 binary bits can be used to represent 2⁴ or 16 different values. In one version, the grayscale levels comprise grayscale bit sets that define less than or about 16 values which, for example, in ascending order of binary numbers may be represented as follows:

| | |
|---|---|
| 0000 | fully off |
| 0001 | 1/15 on |
| 0010 | 2/15 on . . . |
| 1110 | 14/15 on |
| 1111 | fully on. |

However, other grayscale levels or systems may also be used to set up the grayscale image bitmap. For example, the effective imaging resolution of the grayscale image bitmap may be increased by increasing the number of grayscale levels. However, typically, the 4-bit grayscale bit set and associated 16 grayscale levels, is well suited to the resolution provided by current LDI photoresist materials as well as the beam intensity levels attainable by current laser direct imaging apparatus.

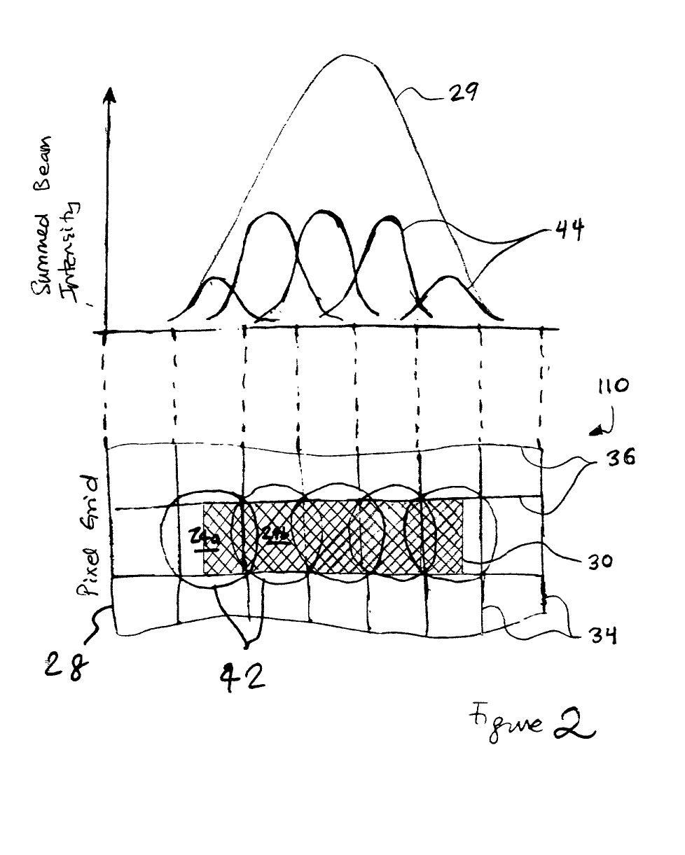

The grayscale image bitmap may be constructed to increase image resolution over conventional two-level image bitmaps. For example, the image pixels lying along the boundaries of image features of an image map may be set to grayscale levels to form a grayscale image bitmap that reduces errors in the registration of the boundaries. A higher resolution image results because the grayscale image bitmap is encoded to modulate the intensities of the scanned laser beams as they shape the boundaries of the image features of the laser patterned image scanned across the circuit board to, for example, smoothen out or more accurately position the straight, curved, or diagonal lines of the boundaries. The grayscale boundary correction occurs because of the overlapping laser beam spots 42 that each have a Gaussian beam spot intensity distribution curve 44 as, for example, shown in FIG. 2. The full width half max (FWHM) of each beam spot 42 defines the beam spot size and is selected to be equal to or larger than the size of the addressable pixel 24 (as defined by the parallel to vertical and horizontal lines 34, 36 of the pixel grid 28) on which the beam spot 42 is projected. As a result, beam spots 42 falling on adjacent pixels 24a, 24b slightly overlap one another to provide a summed beam intensity curve 29 that uniformly covers the surface of the circuit board 110. When the intensity of a beam spot 42 that is imaging a boundary 30 of an image feature is reduced to a fractional intensity of a fully-on beam, the summed beam intensity curve 29 of the overlapping beam spots 42 (i.e., the aerial image) projected on neighboring pixels 24a, 24b results in a fractional shift in imaging position of the boundary 30 of the image feature to a position that is between the grid spacing lines 34, 36. The fractional shift in position is used to increase the accuracy and resolution of the boundaries of the image features of an image feature of a laser patterned image being registered on the circuit board 110. Thus, the grayscale levels may be used to smooth out stepped boundaries and also to improve the positional accuracy or shape of the imaged features.

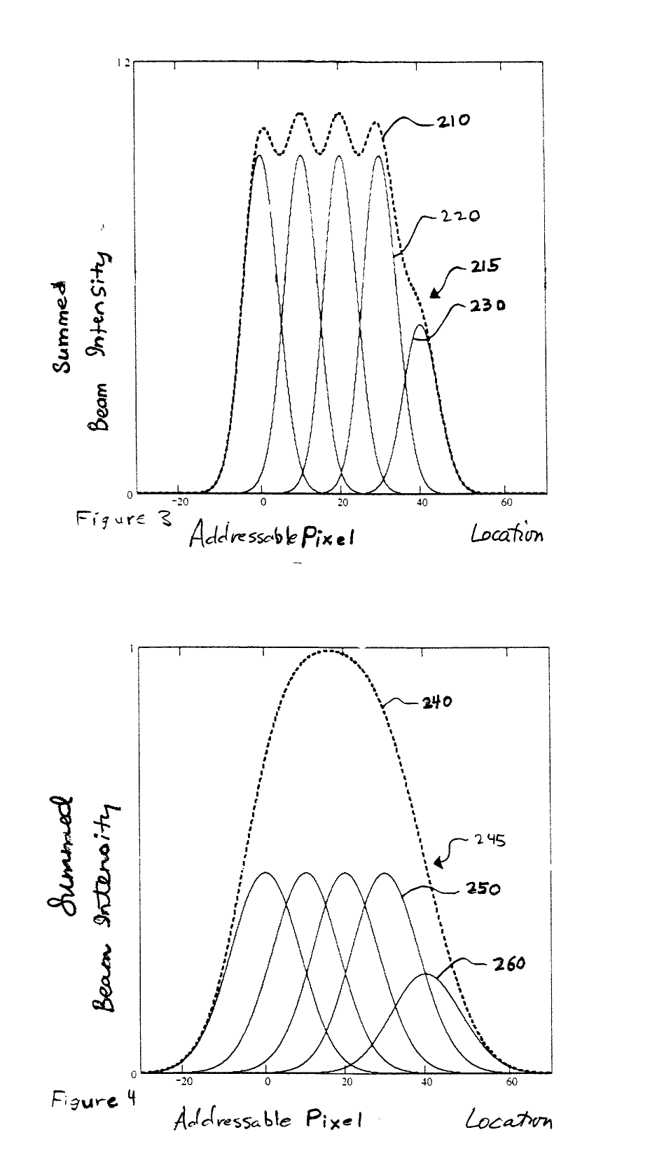

FIGS. 3 and 4 show the effect of different ratios of beam spot size to addressable pixel size on the smoothness of the summed beam intensity curves 210, 240 of the beam spots of beams being scanned across the circuit board 110. In FIG. 3, where the ratio of the beam spot size to the addressable pixel size is 1:1, it is seen that the summed beam intensity curve 210, which represents the summation of the individual beam spot intensity curves 220, 230, has multiple distinct peaks, and that the boundary 215 of the summed beam intensity curve 210 is stepped. In FIG. 4, wherein the ratio of the beam spot size to the addressable pixel size is 2:1, the summed beam intensity curve 240, which represents the summation of the individual beam spot intensity curves 250, 260, has a smoother peak and that the boundary 245 of the curve 240 is also smooth. This demonstrates that the ratio of the beam spot size to the pixel address size affects the smoothness of the boundaries of the image features of the laser patterned image being registered on the circuit board 110.

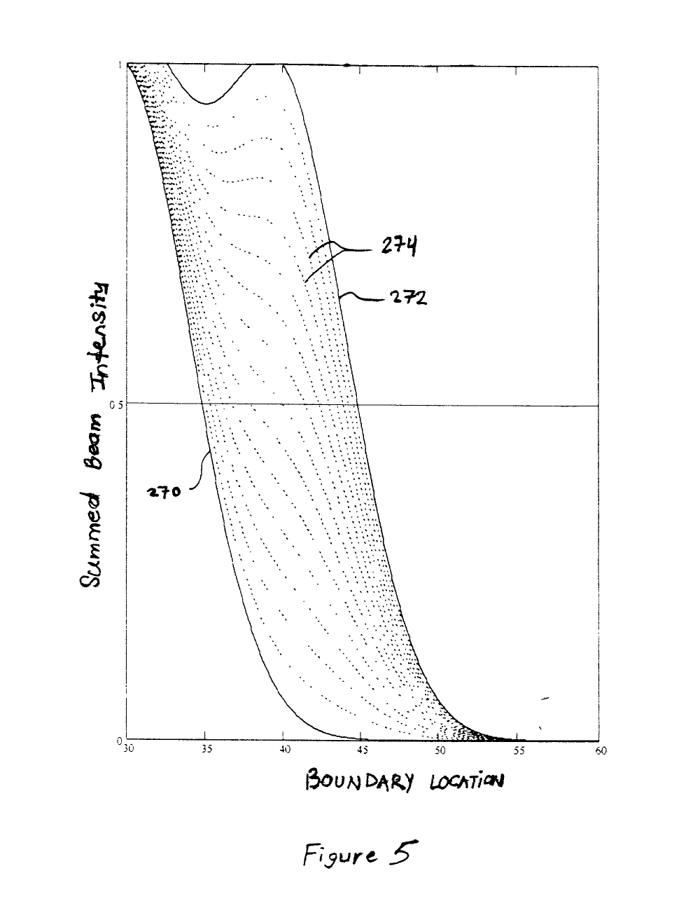

FIGS. 5 and 6 show the changing shape and position of the edge of a summed beam intensity curve at the boundary of two addressable pixels for different ratios of beam spot size to addressable pixel size. In FIG. 5, the ratio of beam spot size to pixel size is 1:1. A fully-on beam is projected on the first pixel and a fractional intensity beam corresponding to one of the 16 grayscale levels is projected onto the second adjacent pixel. As the grayscale level of the beam projected onto the second pixel is increased from 0 to 1 in increments of 1/15, the summation of the beam spot intensities at the boundaries of the two addressable pixels gradually shift from the leftmost solid line 270 which is the summed beam intensity curve that results when the first beam spot is fully on and the second beam spot to the right is fully off. The rightmost solid line 272 is the summed beam intensity curve that results when the left beam spot is fully on and the right beam spot is also fully on. The dotted lines 274 between the two solid lines 270, 272 represent the summed beam intensity curves that result when the left beam spot is fully on and the right beam spot is at each of the fourteen intermediate fractional beam intensities.

FIG. 5 demonstrates that when the ratio of the beam spot size to addressable pixel size is 1:1, the summed beam intensity curves 270, 272, 274 are spaced apart by unequal distances along the horizontal axis and in a non-linear relationship to one another. For example, at the summed beam intensity of 0.5 which typically defines a threshold point for resist exposure and development, the beam intensity curves 274 are bunched together near the left solid line 270 and the right solid line 272. In other words, the change in shape of the summed beam intensity curve that results from an increase in fractional beam from 7/15 to 8/15 is greater than change in shape resulting from a fractional beam intensity increase of from 0 to 1/15 or from 14/15 to 1. The non-linear displacement of the summed beam intensity curve 270, 272, 274 with increasing fractional beam intensity renders a lookup table or other stored non-linear functional relationship desirable to determine the shift in the boundary of the imaged feature from increasing fractional beam intensities.

However, in FIG. 6, where the ratio of the beam spot size to addressable pixel size is 2:1, the summed beam intensity curves 270, 272, 274 are spaced substantially equally along the horizontal axis. In other words, the summed beam intensity curves 270, 272, 274 are displaced in a linear relationship to the fractional beam intensity levels. This is advantageous because a simple linear functional relationship may be used to describe the changing shape of the summed beam intensity curve 270, 272, 274 with increasing fractional beam intensity. Thus, it is advantageous to use a ratio of the beam spot to pixel address size that is at least about 1.2:1 and that may even be at least about or equal to 2:1. In one example, the laser beam 135 comprises an array of beams 135 that each project a beam spot 42 on an addressable pixel 24 on the circuit board 110, and the ratio of the size of the beam spot 42 to the size of the addressable pixel 24 is at least about 1.2:1. However, there are other image fidelity factors that require smaller beam spot to addressable pixel size ratio.

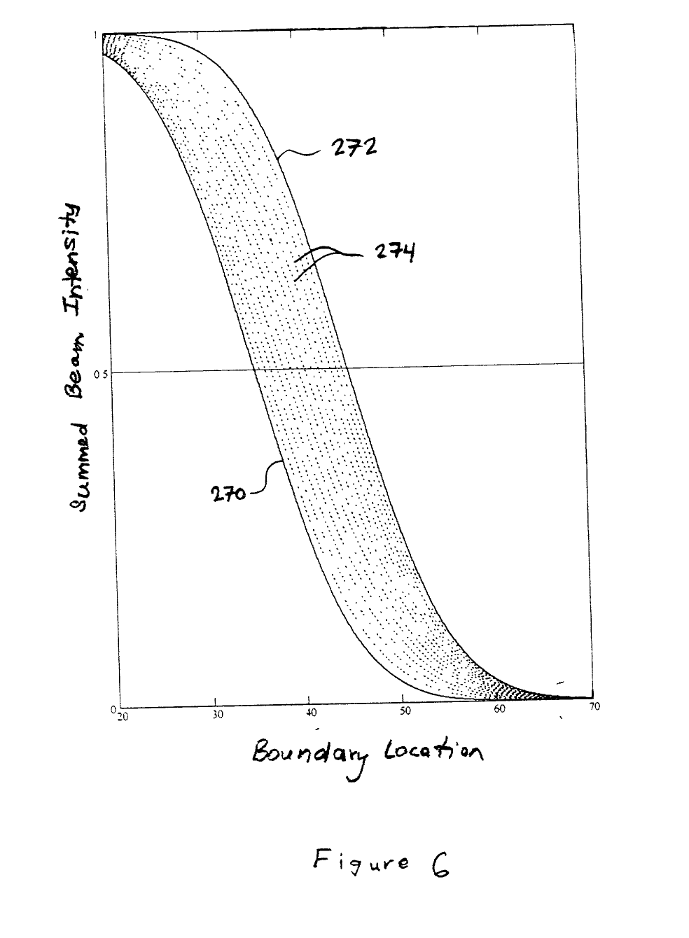

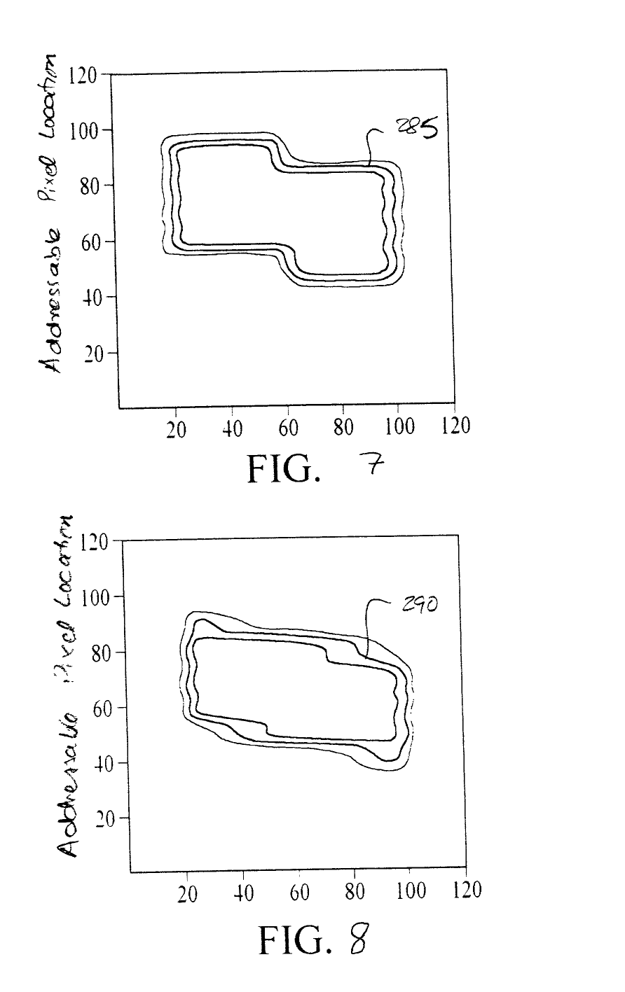

FIGS. 7 and 8 show aerial contour plots of the summed beam intensity of a diagonally oriented imaged feature showing the effect of illuminating the addressable pixels using a two-level bitmap and a grayscale image bitmap, respectively. In these figures, the imaged feature has a diagonally oriented rectangular shape and the ratio of beam spot size to pixel size is 1:1. The contour lines are in decreasing relative intensity proceeding from the inside to the boundary of the diagonally oriented rectangle. In FIG. 7, where the feature was imaged using two levels of beam intensity, “on” and “off”, the boundary 285 of the feature was imaged as two misaligned stepped flat portions and not a diagonally oriented rectangle. In FIG. 8, where the same diagonally positioned rectangle feature was imaged using a grayscale having fractional beam intensities, the boundary 290 of the image feature is much smoother and more closely resembles the intended diagonally oriented rectangle shape with sloped top and bottom boundaries.

As another example, a grayscale image bitmap may also be generated from an image map to more accurately position the boundaries of image features that fall between the grid lines of a pixel grid, such as for example, when a straight boundary of an electrical trace to be imaged onto the circuit board 110 falls between two adjacent parallel lines of the addressable pixel grid. In conventional imaging methods, a two-level image bitmap comprises either a beam fully-on state for an addressable pixel on which the boundary of the line falls if more than 50% of the addressable pixel area is covered, or a beam fully-off state if the boundary of the line covers less than 50% of the addressable pixel area. As a result, the imaged lines registered by the two-level image bitmap may vary in critical dimensions, such as line width, which affect electrical factors such as impedance. In contrast, a grayscale image bitmap is determined by allocating grayscale levels, representing fractional beam intensities, to the addressable pixels corresponding to the boundaries of the line image features. For example, if a line image feature is offset from the pixel grid by a distance of about 20%, the image pixels corresponding to the boundary of the line are allocated fractional beam intensities which would result in a 20% shift in position of the boundary of the line imaged onto the circuit board 110. In contrast, the image pixels 220 in the interior of the imaged line are accorded a full beam intensity of 100%. Because adjacent laser beam spots 210 overlap, the boundaries of the imaged line have an intensity level that correctly positions the line boundaries on the circuit board 110.

Grayscale image correction may also be used to equalize the widths of image features comprising horizontal or vertical lines. The widths of registered horizontal and vertical lines may otherwise be unequal because the lines are registered differently, i.e., a horizontal line is registered by a continuously turned-on beam, whereas a vertical line is registered by a beam that is on at the same horizontal coordinate in each of a number of separate scans. In this version, the side boundaries of the horizontal or vertical lines may be inwardly or outwardly shifted by fractional beam intensities so that the registered image provides the correct separation distance between the lines.

The grayscale image bitmap may also be generated according to other criteria, for example, by applying other types of image correction operators to the image map. Such image correction operators may be dependent on measured characteristics of the circuit board 110. The characteristics may comprise, for example, deviations of fiducial marks 177 on the circuit board 110, variations or anomalies observed on the surface of the registered and etched circuit board by a scanning electron microscope (SEM) examination of the circuit board, or in-situ CCD camera observation of the scanning characteristics of the laser beams being scanned. In the fiducial mark version, the deviations of fiducial marks 177 located on the circuit board 110 are measured by a fiducial mark locator 175, and the grayscale image bitmap is corrected for such deviations by scaling, translating or rotating image features in accordance with the measured fiducial mark deviations. The fiducial marks 177 may be light-reflecting markings, holes, patterns, or diffraction gratings. The fiducial mark locator 175 generally comprises an optical image detector capable of detecting the fiducial marks 177, such as a CCD camera. In the SEM version, an SEM is used to scan a registered and etched circuit board to generate a scan image of the etched pattern, which is then compared with the original intended image to determine feature deviations from which a correction operator is generated. In the CCD camera version, a CCD camera (not shown) observes a laser beam 135 as it scans along a scan line during a calibration step and the observed scan line is compared with an intended scan line to determine scan line deviations from which an image correction operator is generated.

The grayscale image bitmap may also be generated according to imaging criteria, for example, by applying different grayscale levels to the isolated and dense patterns of a circuit image to be registered on a circuit board, or depending upon the imaging characteristics of the laser beam imaging apparatus. The grayscale levels may also be set to depend upon characteristics of post-imaging processes or apparatus, such as the development characteristics of the developer used to develop the circuit image registered on the circuit board 110, or the etching characteristics of the etching equipment used to etch a circuit on the circuit board 110.

As yet another example, a grayscale image bitmap may be generated to compensate for beam scanning or beam modulating errors by mathematical inverse filtering of the errors. Such errors are often inherent characteristics of the imaging apparatus, such as for example, beam bowing errors, which occur when the laser beam scanned across the circuit board generates a slightly curved or arcuate line or feature. The image correction operator attempts to straighten out the upwardly or downwardly curved edges of the bowed line or feature to provide a straighter line. This may be accomplished, for example, by increasing the grayscale levels of the image pixels on the side of the curved portion of the bowed line or feature and reducing the grayscale levels of the image pixels on the other side of bowed feature to more closely replicate a straight line. As an example, assume a horizontal line feature is imaged as concave arc with upward edge portions and a downward central portion, due to optical bow error. If the center of a horizontal line is regarded as a reference point, while traveling to the edges of the horizontal line the left and right hand sides of the arc must be moved increasingly downward to correct for the optical bowing error. Focusing on the far left corner of the horizontal line, the top portion must move down by reducing the gray levels at the top boundary, while the bottom side must also move down, but by increasing the gray levels at the bottom boundary.

An image correction operator to correct for such deviations may be calculated using the measured deviation between an intended position of an image feature and an actual position from:

ib(x,y)=o(x,y)** t(x,y) (1)

where ** is a mathematical convolution in the two dimensional spatial domain, o(x,y) is the intended image map, ib(x,y) is the measured registered image, and t(x,y) is the undesirable beam scanning or modulating distortion function. This may also be seen by applying the convolution theorem to (1) to yield:

IB(X,Y)=O(X,Y)·T(X,Y) (2)

where · is multiplication, the functions are the Fourier transforms of their respective spatial domain functions in (1), and (X,Y) are the two frequency dimensions corresponding to the spatial dimensions (x,y). From IB(X,Y) and O(X,Y), T(X,Y) may be calculated, and O(X,Y) may be intentionally distorted to O'(X,Y)=O(X,Y)·T(X,Y)ˆ (−1). By attempting to register O'(X,Y), the apparatus may register the intended image map O(X,Y):

IB(X,Y)=O'(X,Y)·T(X,Y)=O(X,Y)·T(X,Y)ˆ (−1)·T(X,Y)=O(X,Y) (3)

In one embodiment, the filter is used for low spatial frequency compensation. In addition, using IB(X,Y), other modifications that are more efficiently carried out in the frequency domain may be applied to the image map, such as for example, low-pass filtering, or band-pass filtering.

In another aspect of the present invention, a contour filter may be used before or after image correction to filter an image map to generate a contour image map containing substantially only the contours of the image features of the image map. The contours comprise the boundaries of the image features, such as the sides of a rectangle or the circumferential perimeter of a circle. The contour image map may be substantially smaller than the original image map to speed up processing of the image registration data. The contour image map is useful because typically the image pixels change in intensity only at the contours of an image feature and the image pixels on either side of the contour are at the same fully on or off state. Thus, when a laser beam is used to register an image feature on a circuit board, the beam may require modulation substantially only about the contour of the image feature. For example, if an image feature is enlarged, rotated, or deformed, the contour of the image feature may change, but the pixels within the contour may all have a uniform value, such as a fully on or fully off state.

For example, the contour filter may generate a contour image bitmap by reading an image map and identifying the image pixels that change in value. For example, when the contour filter reads an image pixel of the image map that is adjacent to other image pixels and has the same pixel value, it writes a zero value in the corresponding location of that pixel in the contour image bitmap; and when the contour filter reads an image pixel adjacent to another image pixel having a different value, it writes a non-zero pixel value to the contour image bitmap. The contour filter may write the contour image bitmap simultaneously with or after reading the image bitmap. The contour filter may also be used in conjunction with a fill filter that fills-in the missing pixels in the contours of the contour image or other processed bitmap before the final image is registered on the circuit board.

The contour filter may be used to more efficiently process an image map. For example, an exemplary image map may comprise an image feature comprising a solidly filled-in circle, and an exemplary image correction process may desire to enlarge the circle. The contour filter can process the filled-in circle to generate an empty circle in the contour image map. The contour image map may then be processed much faster to enlarge the empty circle because substantially less data is processed. Thereafter, the fill filter may be used to fill-in the enlarged empty circle to generate a solidly filled-in enlarged circle when processing the image or in the generation of an image bitmap.

The contour image map may also be efficiently further processed to, for example, generate a grayscale image bitmap for registration of the image. Since the intermediate grayscale values are placed along the contours of features of the image map, grayscale processing of the contour image map is much faster than grayscale processing of the entire image map which is not contour filtered. Thus, the contour image map may be processed to generate a grayscale image bitmap comprising grayscale levels, which is then used to register the circuit image on the circuit board 110.

In another version, an image map may be processed by a proximity-effect corrector to compensate for the mis-registration of proximately located pixels, which may occur for pixels located at the boundaries or corners of image features that interfere or cause errors in the registration of other proximate pixels. Typically, in the registration of an image, a laser beam that illuminates one addressable pixel on the circuit board may partially overlap into and illuminate other adjacent addressable pixels. Because of this proximity effect, the overall illumination level received by an addressable pixel also depends on the illumination received by adjacent pixels. For example, illuminated pixels that are adjacent to one another may receive more overall illumination due to one another's overlapping illumination than pixels which are substantially isolated. Other proximity effects may be caused by resist adhesion, development, or etch processes. As a result, image features that are registered onto the circuit board 110 may not accurately match in shape or size the original image features of the image map. For example, the angled edges of a feature in an image map may be registered as rounded edges in the registered image. In another example, the image comprises a filled-in rectangle with right-angled corners may be registered as a rectangle having rounded corners and the area of the registered rectangle may become smaller. Other proximity errors may cause line ends to become shorter or longer and line widths to decrease or increase in size, respectively.

The proximity-effect corrector may be used to compensate for these proximity effects by reading an image map and generating a proximity-corrected image map. The proximity-corrected image map may be used to modulate the laser beams to more accurately register the desired image. For example, a proximity-corrected image map may be generated for a filled-in rectangle in which the edges of the rectangle are enlarged or exaggerated. Although the proximity-corrected rectangle may not accurately resemble the original rectangle, the proximity-corrected rectangle of the registered proximity-corrected image will more accurately resemble the rectangle in the original image map because, for example, the enlarged edges compensate for the lower illumination levels received by the corner addressable pixels. In the same way, a proximity-corrected image map may be generated to increase the lengths of lines that would become shorter or to compensate for altered line widths. A grayscale image bitmap may also be generated using the proximity-effect corrector by setting image pixels near the corners or edges of an image feature at grayscale levels corresponding to fractional beam intensities to accurately correct for the proximity errors by outwardly expanding or exaggerating the corners or edges.

In yet another aspect of the present invention, a data compressor may be used to compress an image bitmap to a compressed data form to minimize the required bandwidth and efficiently store the image bitmap. The image bitmap may be, for example, a grayscale image bitmap or proximity-corrected image bitmap. The data compressing may be done by a compression algorithm that reduces the transmission bandwidth required to transmit the data. In one version of the compression algorithm, binary bit sets for each laser beam scan line are compressed into a series of binary bit sets that provide a smaller data representation of each scan line. This data compression system is advantageous where there are a number of electrical trace lines running parallel to the pixel grid lines, which for example, may be represented by “x” multiplier data bits and a laser beam “on” data bit for the entire line length; whereas the adjacent empty lines may be represented by “x” multiplier data bits and a laser beam “off” data bit for the entire line length. Typically, the compressed data is decompressed just before it is transmitted to the beam modulator, for example, by a decompressor component that operates a decompressing algorithm.

In one version, the compression algorithm is lossless to retain the full integrity or information content of the image bitmap after both compression and decompression. One version of a lossless compression algorithm is run-length encoding (RLE) which may be implemented in a variety of schemes. In one version, grayscale levels are defined by 4 binary bits; however, a similar scheme is applicable to 2 to 5-bit (or more) pixel data. In an exemplary format of a 4-bit RLE compression scheme, each 16-bit sequence comprises four 4 bit sequences. The first bit of the 16-bit sequence is the MSB, which is indicative of a repeat, copy, or additional commands. If the MSB is 0 and the next 11 bits are non-zero, the 11 bits indicate the number of image pixels that should be repeated (i.e., 1≦count≦2047). If the MSB is 0 and the 11 bits are zero, the remaining 4 bits are mapped to one of 16 different commands (e.g., line copy, block copy, end of line, etc.). If the MSB is 1, the remaining 15 bits indicate the number of image pixels that should be copied (i.e., 2≦count≦32767). In this case, the next 16-bit sequence consists of four 4-bit sets corresponding to the four image pixels to be copied. If count is greater than 4, more than one 16-bit sequence will be followed and copied. As an example, if the MSB is 1 and the count is 10, the next three 16-bit sequences will be copied, for example, eight 4-bit pixels from the first two sequences and two more pixels from the third sequence.

The grayscale and image correction features of the present invention are useful for registering a laser beam image comprising a pattern representative of circuit lines or electronic circuitry directly on a circuit board 110, an exemplary version of which is shown in FIG. 9. The illustrative circuit board 110 provided herein should not be used to limit the scope of the invention, and the invention encompasses equivalent or alternative circuit boards or other non-electronic patterns, as would be apparent to one of ordinary skill in the art. The circuit board 110 typically comprises a dielectric 60, such as a polymer composite, for example, a thermosetting epoxy resin infiltrated into a reinforcing material, such as for example, glass cloth, such as FR₄ (TM) which is commercially available from Brain Power Co., Taipei, Taiwan. A conducting layer 70 on the dielectric layer 60 comprises one or more layers of metal, such as copper. A photoresist layer 80 overlying the conducting layer 70 is exposed to a laser patterned image and then developed to form a pattern of resist features overlying the conducting layer 70. The photoresist layer 80 comprises photoresist material that is adapted to the specifics of the laser beam projected onto the circuit board 110. For example, some photoresist materials may be well-suited to on/off modulation of the laser beam, while other photoresist materials may be well-suited to fractional intensities of the laser beam (for example, if they are more capable of being partially polymerized). For dry resist, the circuit board 110 may be covered with a UV-transparent sheet of Mylar (TM, E. I. du Pont de Nemours and Company, Wilmington, Delaware) 90 to prevent oxygen inhibition prior to polymerization of resist. The conducting layer 70 of the patterned circuit board 110 is then etched to form a pattern of electrically conducting lines and other features. A number of such circuit boards 110 may be joined with an adhesive, with laser holes drilled through, and conducting vias formed in the through-holes to join the conducting features and lines to one another.

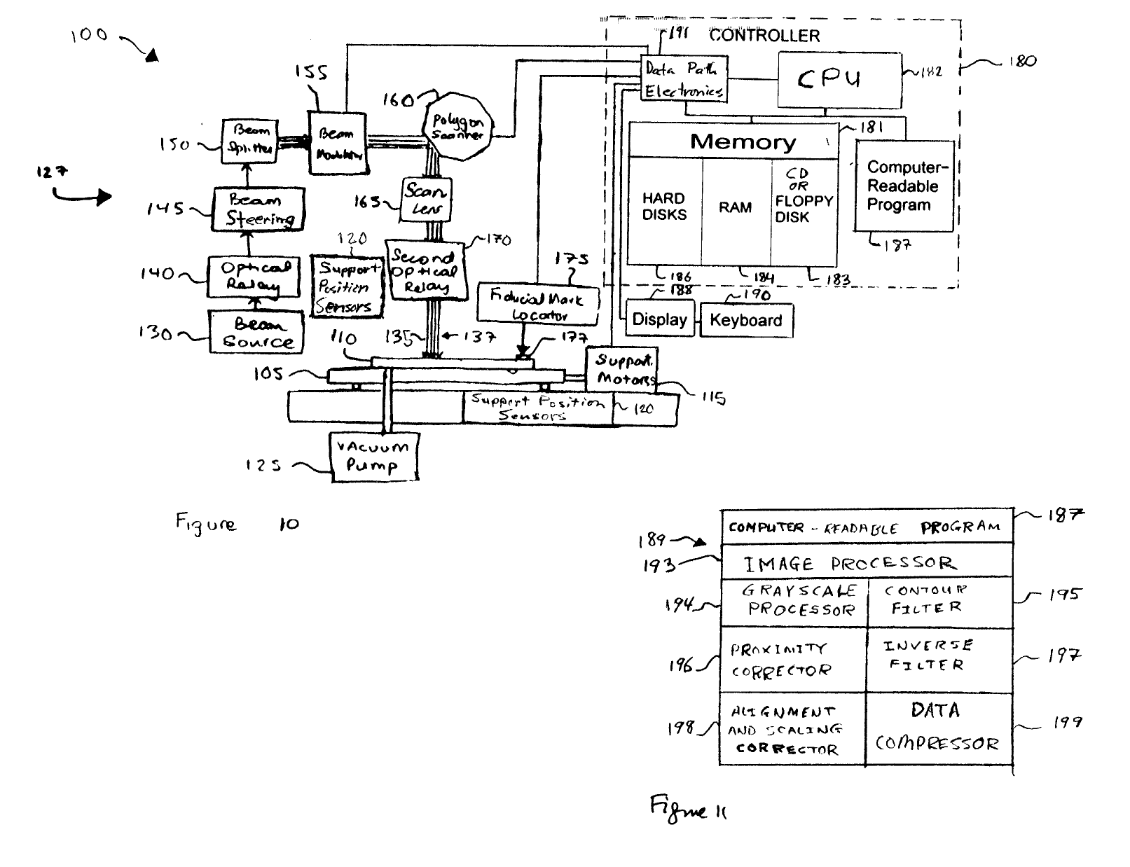

An exemplary version of an imaging apparatus 100 according to the present invention to register the image on the circuit board 110 is schematically illustrated in FIG. 10. The illustrative apparatus provided herein should not be used to limit the scope of the invention, and the invention encompasses equivalent or alternative apparatus versions, as would be apparent to one of ordinary skill in the art. Generally, the apparatus 100 comprises a support 105 having a platen (not shown) capable of supporting a circuit board 110. Support motors 115 are provided to move the support 105 to precisely position or move the circuit board 110. For example, the support motors 115 may comprise electric motors that translate the support 105 in the x and y directions along the x-y plane parallel to the circuit board surface, rotate the support 105, or raise and lower the support 105. Support position sensors 120 are provided to determine the position of the support 105, such as its location in the x-y plane, its vertical offset, its angular offset, or its tilt. For example, the position sensors 120 may operate by detecting a light beam reflected off the circuit board 110 or support 105. A vacuum pump 125 is connected to a vacuum channel (not shown) in the support 105 to hold the circuit board 110.

A laser beam source 130 is provided to generate a laser beam 135 that may be projected onto the circuit board 110 in a pattern corresponding to the desired image. The laser beam source 130 may comprise, for example, an ultraviolet light, visible light, or infrared light source. The laser beam source 130 may be continuous-wave (CW) or pulsed (e.g., mode-locked solid state). A suitable laser beam source 130 comprises a UV laser, such as a CW laser having primary spectral lines at 351 nm, 364 nm, 380 nm, and 385 nm. The laser beam source 130 generates a collimated multi-wavelength light beam 135 that travels along a beam path 137 to the circuit board 110.

A first optical relay 140 in the beam path 137 may be used to transmit the laser beam 135 from the laser beam source 130 to an automatic beam steering module 145, which provides a position-stabilized beam to a beam splitter 150. The beam splitter 150 splits the stabilized laser beam into a plurality (for example, two, four, or eight) of telecentric, equal-power laser beams 135.

The laser beams 135 are provided to a beam modulator 155 that modulates the beams 135 according to the image map to register an image on the circuit board 110. The beam modulator 155 may comprise, for example, an acousto-optic modulator (AOM) that uses constructive or destructive interference of the laser beams 135 passing through the crystal, thereby permitting the beams 135 to be modulated. Electrical data signals coupled to the beams 135 in the AOM are used to modulate the laser beams 135 by changing the intensities of the individual beams 135 according to a predefined grayscale.

A rotating polygon mirror 160 is used to scan the modulated laser beams along a scan direction across the circuit board 110, while the circuit board support 105 may be moving the circuit board 110 in a substantially perpendicular cross-scan direction. The polygon mirror 160 rotates about an axis which changes the angles of reflection of the laser beams 135 to scan the beams 135 along a scanning stripe. A scan lens 165 focuses the modulated and scanned beams 135 to, for example, reduce the separation between beams 135, by providing an anamorphic magnification between the scan direction and the cross-scan direction. A second optical relay 170 reforms the image formed by the scan lens 165 and may be used to reduce optical constraints on the scan lens assembly as well as to provide the desired magnification.

A controller 180 comprising a suitable configuration of hardware and software is used to operate the apparatus components 127 to register an image on the circuit board 110, and optionally, also to process an image map to generate the grayscale image bitmap according to the present invention. For example, the controller 180 may comprise a central processing unit (CPU) 182, such as a complex instruction set computer (CISC) processor, for example a Pentium processor commercially available from Intel Corporation, Santa Clara, Calif., or a reduced instruction set computer (RISC) processor, capable of executing a computer-readable program 187, and that is coupled to a memory 181 and other components. The memory 181 may comprise computer-readable medium such as hard disks 186, for example, a redundant array of independent disks (RAID), a compact disc or floppy disk 183, random access memory (RAM) 184, and/or other types of volatile or non-volatile memory. The interface between an operator and the controller 180 can be, for example, via a display 188, such as a cathode ray tube (CRT) display, and an input device, such as a keyboard 190. The controller 180 may also include data path electronics 191 such as analog and digital input/output boards, linear motor driver boards, or stepper motor controller boards. The computer-readable program 187 generally comprises software comprising a set of instructions to operate the components 127. The computer-readable program 192 can be written in any conventional programming language, such as for example, assembly language, C, C++ or Pascal. Suitable program code is entered into a single file, or multiple files, using a conventional text editor and stored or embodied in the memory of the controller 180. If the entered code text is in a high level language, the code is compiled, and the resultant compiler code is then linked with an object code of pre-compiled library routines. To execute the linked, compiled object code, the user invokes the feature code, causing the CPU 182 to read and execute the code to perform the tasks identified in the computer-readable program 187.

The controller 180 is adapted to generate, send, and receive signals to operate components 127 such as the laser beam source 130, the beam modulator 155, beam detectors, stage motors 115, and also the fiducial mark locator 175 to register an image on the circuit board 110. For example, the controller 180 may send signals to the beam modulator 155 to control modulation of the laser beams 135 to the desired intensity levels and in correspondence to an image bitmap of an image to be registered on a circuit board 110. The beam modulator 155 may also be controlled to scale the image in the scanning direction by timing the beam pulses, and the support motors 115 may also receive real-time instructions from the controller 180 to control the motion of the circuit board 110 to scale, rotate, or offset the image registered on the circuit board 110. The controller 180 may also operate the fiducial mark locator 175 by receiving measured locations of the fiducial marks 177 and comparing them to their original or design locations to determine the deviation of each fiducial mark 177.

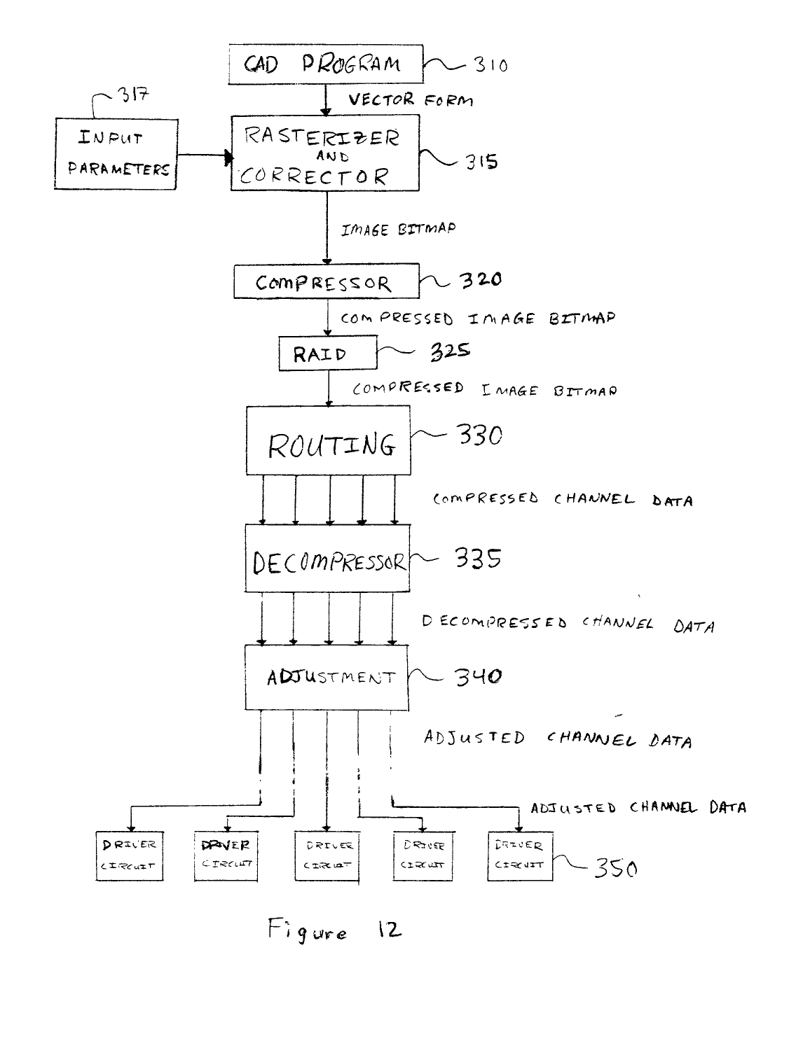

The controller 180 may also comprise an image processor 189 to process the image to be registered onto the circuit board 110. The image processor 189 may comprise software that is part of the computer-readable program, as shown in FIG. 11, or may be a hardware component, such as a programmable integrated circuit (not shown). Additionally, the image processor 189 may be capable of operating substantially independently of the other apparatus components. The image processor 189 receives the vector image map and predetermined or measured image processing parameters to process the vector image map to a form suitable for modulating the laser beams projected onto the circuit board 110. Thus, an exemplary image processor 193 may comprise, for example, a bitmap processor to convert a vector image map to an image bitmap; a grayscale processor 194 to convert a vector image map or high-resolution two-level image bitmap to a grayscale image bitmap; a contour filter 195 to read an image map and generate a contour image map containing only the contours in the image map; a proximity-effect corrector 196 to correct for proximity effects; an inverse filter 197 to mathematically inverse filter an image map in the frequency or spatial domain; an alignment and scaling corrector 198 to receive fiducial mark deviation values, an SEM scan of the registered circuit board 110, or a CCD camera picture of laser beam positions used as an input to the inverse filter 197, to calculate support translation and rotation values, and image scaling values therefrom; and a data compressor 199 to compress the signal data to be transmitted to a decompressor nearer to the beam modulator components.

The controller 180 may be programmed to generate the grayscale image bitmap by assigning grayscale levels to the image pixels according to some predefined criteria. For example, the controller may be programmed to assign grayscale levels to the image pixels located along the boundaries of the image features of an image map of a circuit image to be registered on the circuit board, assign grayscale levels in relation to a scanning position of the laser beam 135, assign grayscale levels in relation to a beam bowing error of the laser beam 135, and assign grayscale levels in relation to a measured surface anomaly of the circuit board 110. In yet another example, the controller 180 may also be programmed to generate a contour image map from the image map or grayscale image bitmap, and optionally to fill in the image pixels lying within the contours of the contour image map. After the image processor 189 calculates a corrected image bitmap, the corrected image bitmap may be further processed, or may be transmitted to the beam modulator 155 in the form of a data signal, and registered on the circuit board 110.

In operation, as illustrated in FIG. 12, a vector image map is typically generated, such as in a computer-aided design (CAD) program 310. The vector image map is bitmapped to a grayscale image bitmap by a grayscale rasterizer 315. One or more of the image corrections may be applied by the grayscale rasterizer 315 to produce a grayscale image bitmap that compensates or corrects for image mis-registration. Input parameters 317, such as the correction determined from the support camera calibration step, are input into the grayscale rasterizer 315. The grayscale image bitmap is then compressed by the compressor 320 and transferred to the RAID 325, where it is stored in compressed form. The final compensated grayscale image stored on the RAID 325 is ready to be imaged when the user desires. After a circuit board 110 is placed on the support 105, the data from the RAID 325 is routed to separate the incoming stream of data to data signals in different channels, as in step 330. The data signal for each channel is then decompressed by a decompressor 335. The decompressed data signal is then adjusted for other machine-specific parameters such as timing and scan intensity variations, as in step 340. The data signal for each channel is finally sent to its corresponding driver circuit 350, which controls the intensity of an AOM channel.

Thus, the present apparatus and method is advantageously capable of increasing the resolution of an image being registered on a circuit board without excessively slowing down the imaging process. Although the present invention has been described in considerable detail with regard to certain preferred versions thereof, other versions are possible. Thus, the appended claims should not be limited to the description of the preferred versions contained herein.

What is claimed is:

1. An apparatus capable of registering a laser pattern image on a circuit board, the apparatus comprising:
laser beam source, modulating and scanning components capable of generating, modulating and scanning one or more laser beams across a circuit board held on a support; and
a controller adapted to provide a data signal to operate the components to register a laser patterned image on the circuit board, the data signal relating to a grayscale image bitmap comprising image pixels that are assigned grayscale levels that correspond to fractional beam intensities.

2. An apparatus according to claim 1 wherein the grayscale levels comprise less than or about 16 values.

3. An apparatus according to claim 2 wherein each grayscale level is defined by 4 binary bits.

4. An apparatus according to claim 1 wherein the controller is adapted to process an image map to generate the grayscale image bitmap.

5. An apparatus according to claim 4 wherein the controller generates the grayscale image bitmap by assigning grayscale levels to image pixels that lie along the boundaries of image features in the image map.

6. An apparatus according to claim 4 wherein the controller generates the grayscale image bitmap by assigning grayscale levels to image pixels to compensate for beam scanning or modulating errors by mathematical inverse filtering of the errors.

7. An apparatus according to claim 4 wherein the controller generates the grayscale image bitmap by assigning grayscale levels to image pixels to compensate for one or more of a measured characteristics of the circuit board, isolated versus dense patterneds of an image to be registered on the circuit board, the imaging characteristics of the imaging apparatus, the characteristics of post-imaging processes or apparatus.

8. An apparatus according to claim 4 wherein the controller generates the grayscale image bitmap by assigning grayscale levels to image pixels to compensate for surface anomalies of the circuit board.

9. An apparatus according to claim 4 wherein the controller generates a contour image map from the image map or grayscale image bitmap.

10. An apparatus according to claim 1 wherein the controller comprises a data compressor to compress the data signal and a decompressor to decompress the data signal.

11. An apparatus according to claim 1 wherein the laser beam comprises an array of beams that each cover a beam spot on an addressable pixel on the circuit board, and wherein the ratio of the size of the beam spot to the size of the addressable pixel is at least about 1.2:1.

12. A method of registering a laser patterned image on a circuit board, the method comprising:
(a) placing a circuit board on a support; and
(b) generating, modulating and scanning one or more laser beams across the circuit board on the support, in relation to a grayscale image bitmap comprising image pixels that are assigned grayscale levels that correspond to fractional beam intensities, to register a laser patterned image on the circuit board.

13. A method according to claim 12 wherein the grayscale levels comprise less than or about 16 levels.

14. A method according to claim 12 wherein each grayscale level comprises 4 binary bits.

15. A method according to claim 13 comprising processing an image map to generate the grayscale image bitmap.

16. A method according to claim 15 comprising processing the image bitmap to assign grayscale levels to image pixels that lie along the boundaries of image features in the image map.

17. A method according to claim 15 comprising processing the image bitmap to assign grayscale levels to image pixels to compensate for beam scanning or modulating errors by mathematical inverse filtering of the errors.

18. A method according to claim 15 comprising processing the image bitmap to assign grayscale levels to image pixels to compensate for beam bowing errors.

19. A method according to claim 15 comprising processing the image bitmap to assign grayscale levels to image pixels to compensate for surface anomalies of the circuit board.

20. A method according to claim 15 comprising generating a contour image map from the image bitmap or the grayscale image bitmap.

21. A method according to claim 12 comprising scanning a laser beam comprising an array of beams that each have a beam spot covering an addressable pixel on the circuit board, and wherein the ratio of the size of beam spot to the size of the addressable pixel is at least about 1.2:1.

22. An apparatus capable of registering a laser patterned image on a circuit board, the apparatus comprising:
laser beam source, modulating and scanning components capable of generating, modulating and scanning one or more laser beams across a circuit board held on a support; and
a controller adapted to provide a data signal to operate the components to register a laser patterned image on the circuit board, the data signal derived from a contour image map.

23. An apparatus according to claim 22 wherein the controller is adapted to process an image map to generate the contour image map.

24. An apparatus according to claim 23 wherein the controller processes the contour image map to generate a filled-in image map, and provides a data signal derived from the filled-in image map.

25. An apparatus according to claim 24 wherein the controller processes the filled-in image map to generate a grayscale image bitmap comprising image pixels having grayscale levels that correspond to fractional beam intensities, and provides a data signal derived from the grayscale image map.

26. A method of registering a laser patterned image on a circuit board, the method comprising:
(a) placing a circuit board on a support; and
(b) generating, modulating and scanning one or more laser beams across the circuit board on the support, in relation to a contour image map, to register a laser patterned image on the circuit board.

27. A method according to claim 26 comprising processing an image map to generate the contour image map.

28. A method according to claim 27 comprising processing the contour image map to generate a filled-in image map.

29. A method according to claim 28 comprising processing the filled-in image map to generate a grayscale image bitmap comprising image pixels having grayscale levels that correspond to fractional beam intensities.

30. An apparatus capable of registering a laser patterned image on a circuit board, the apparatus comprising:
laser beam source, modulating and scanning components capable of generating, modulating and scanning one or more laser beams across a circuit board held on a support; and
a controller adapted to provide a data signal to operate the components to register a laser patterned image on the circuit board, the data signal adapted to compensate for a proximity error arising from image pixels located at the boundaries of image features of the laser patterned image to be registered on the circuit board.

31. An apparatus according to claim 30 wherein the controller is adapted to provide a data signal to correct the proximity error by assigning grayscale levels to the image pixels located at the boundaries of image features.

32. A method of registering a laser patterned image on a circuit board, the method comprising:
(a) placing a circuit board on a support; and
(b) generating, modulating and scanning one or more laser beams across the circuit board on the support, to compensate for a proximity error arising from image pixels located at the boundaries of the image features of the laser patterned image to be registered on the circuit board.

33. A method according to claim 33 comprising compensating for the proximity error by assigning grayscale levels to the image pixels located at the boundaries of image features.
